(19) United States
(12) Patent Application Publication
(10) Pub. No.: US 2013/0204952 A1
(43) Pub. Date: Aug. 8, 2013

(54) METHOD AND SYSTEM FOR ELECTRONIC COLLABORATION

(71) Applicants: Paul Everton, Chicago, IL (US); Erich Luedtke, Chicago, IL (US)

(72) Inventors: Paul Everton, Chicago, IL (US); Erich Luedtke, Chicago, IL (US)

(21) Appl. No.: 13/757,937

(22) Filed: Feb. 4, 2013

Related U.S. Application Data
(60) Provisional application No. 61/594,204, filed on Feb. 2, 2012.

(51) Int. Cl. H04L 12/58

(52) U.S. Cl. CPC H04L 51/00
USPC 709/206

(57) ABSTRACT

A computing device may be operable to receive a first email via a network connection. The computing device may be operable to parse a first email to extract one or more fields of the first email. The computing device may be operable to determine, based on the extracted field(s), a category of an electronic forum with which to associate the first email. The computing device may be operable to determine, based on the extracted field(s), a thread of the determined category with which to associate the first email. The computing device may be operable to associate, in a memory, the first email with the determined thread. The computing device may be operable to present content of the first email in a first post in the determined thread.

### CLAIM OF PRIORITY

This patent application makes reference to, claims priority to and claims benefit from U.S. Provisional Patent Application Ser. No. 61/594,204 titled “Systems and Methods for Communications Between Corporate Social Networks” and filed on Feb. 2, 2012.

The above-identified application is hereby incorporated herein by reference in its entirety.

### BACKGROUND

Existing systems and methods for electronic collaboration can be inefficient and inflexible. Further limitations and disadvantages of conventional and traditional approaches will become apparent to one of skill in the art, through comparison of such approaches with some aspects of the present method and system set forth in the remainder of this disclosure with reference to the drawings.

### BRIEF SUMMARY

A method and/or system is provided for electronic collaboration, substantially as illustrated by and/or described in connection with at least one of the figures, as set forth more completely in the claims.

### BRIEF DESCRIPTION OF THE DRAWINGS

FIG. 1 depicts an example computing environment for electronic collaboration.

FIG. 2A depicts an example computing device operating as a web and email server.

FIG. 2B depicts an example computing device operating as a web and email client.

FIG. 3 depicts example fields of an email.

FIG. 4 is a flowchart illustrating an exemplary process for electronic collaboration.

FIG. 5 is a flowchart illustrating an exemplary process for electronic collaboration.

FIGS. 6A-6C depict example graphical user interfaces of an electronic forum.

FIGS. 7A and 7B depicts example emails corresponding to the forum thread shown in FIG. 6A.

FIG. 8 is a flowchart illustrating an exemplary process for electronic collaboration.

### DETAILED DESCRIPTION

As utilized herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, “and/or” means any one or more of the items in the list joined by “and/or”. As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}. As utilized herein, the term “exemplary” means serving as a non-limiting example, instance, or illustration. As utilized herein, the terms “e.g.,” and “for example” set off lists of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled, or not enabled, by some user-configurable setting. As utilized in the claims, ordinal numbers (“first,” “second,” and so on) are used for distinguishing claim terms and not for establishing order or precedence of the claim terms.

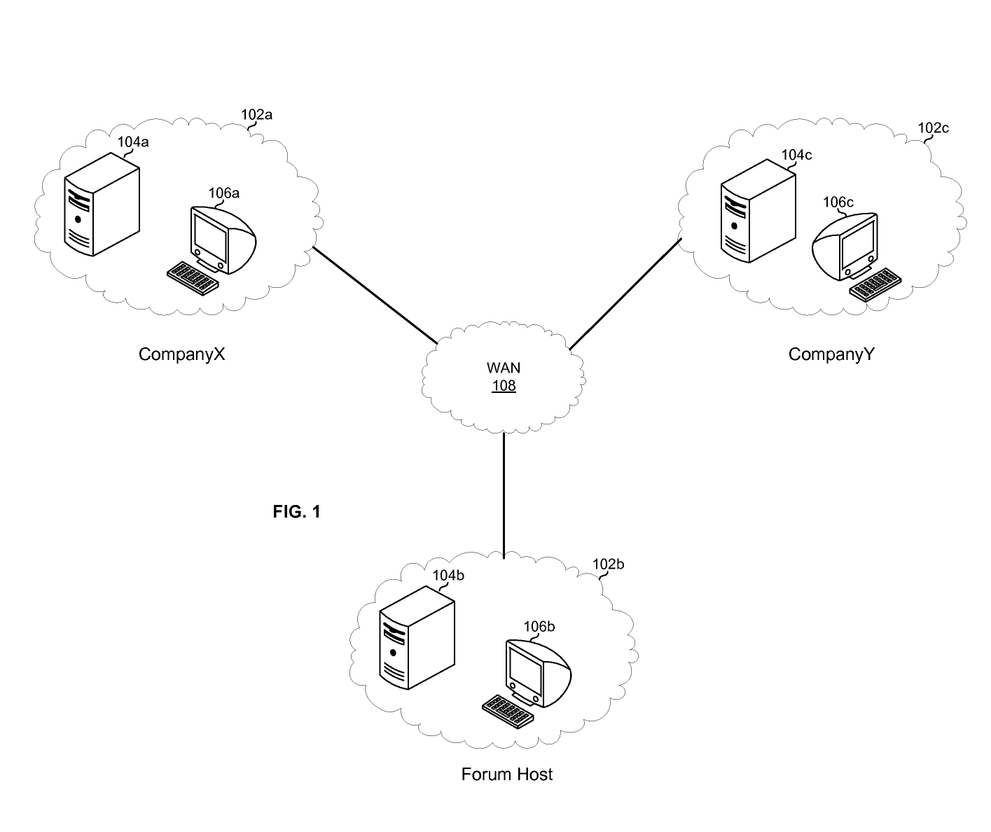

FIG. 1 depicts an example computing environment for electronic collaboration. Shown is a local area network (LAN) 102a of a first entity (“CompanyX”) comprising a computing device 104a (e.g.,and an computing device 106a, a LAN 102b of a second entity (“Forum Host”) comprising a computing device 104b and an computing device 106b, a LAN 102c of a third entity (“CompanyY”) comprising a computing device 104c and an computing device 106c, and a wide area network (WAN) 108 via which the three LANs are interconnected.

Each of the LANs 102a-102c comprises a respective one of computing devices 104a-104d, a respective one of computing devices 106a-106c, and network plumbing (routers, switches, cables, etc.). Examples of computing devices include, desktop computers, laptop computers, tablet computers, smartphones, stand-alone servers, rack-mounted servers, and the like. In an example implementation, the computing devices 104a and 104c may operate as email servers, the computing device 104b may operate as an email server and web (or application) server, and the computing devices 106a-106c may each operate as an end-system (e.g., personal computer, tablet computer, and/or smart phone).

Each of the computing devices 104a-104c may comprise circuitry operable to process (e.g., read from memory, perform logic and/or arithmetic operations on, packetize according to one or more communication protocols, and/or the like) data to be sent via a network connection, send data via a network connection, receive data via a network connection, and process (e.g., write to memory, perform logic and/or arithmetic operations on, depacketize according to one or more communication protocols, and/or the like.) data received via a network connection. Such data may include, for example, data formatted and communicated in accordance with one or more email-related standards (e.g., RFC 5321, RFC 5322, POP3, IMAP4, etc.), one or more Internet-related standards (e.g., HTML, HTTP, TCP/IP, etc.), and/or in one or more vendor-specific Application Programming Interfaces (APIs). Such circuitry may enable each of the computing devices 104a-104c to operate as an email server, and email parser, a web server, and/or a vendor-specific application server.

Each of the computing devices 106a-106c may comprise circuitry operable to process (e.g., read from memory, perform logic and/or arithmetic operations on, packetize according to one or more communication protocols, and/or the like) data to be sent via a network connection, send data via a network connection, receive data via a network connection, and process (e.g., write to memory, perform logic and/or arithmetic operations on, depacketize according to one or more communication protocols, and/or the like) data received via a network connection. Such data may include, for example, data formatted and communicated in accordance with one or more email-related standards (e.g., RFC 5321, RFC 5322, POP3, IMAP4, etc.), one or more Internet-related standards (e.g., HTML, HTTP, TCP/IP, etc.), and/or in one or more vendor-specific Application Programming Interfaces (APIs). Such circuitry may enable each of the end-systems 106a-106c to operate as an email client, a web client, and/or run a vendor-specific application client.

The WAN 108 may comprise, for example, network “plumbing” such as routers, switches, cables, etc. The WAN 108 may be, for example, the Internet.

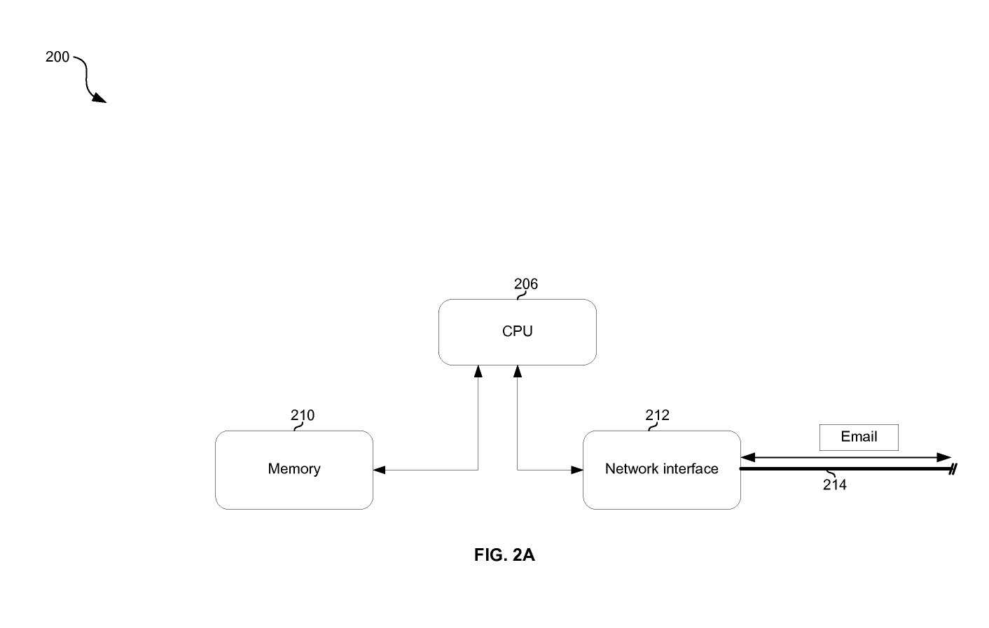

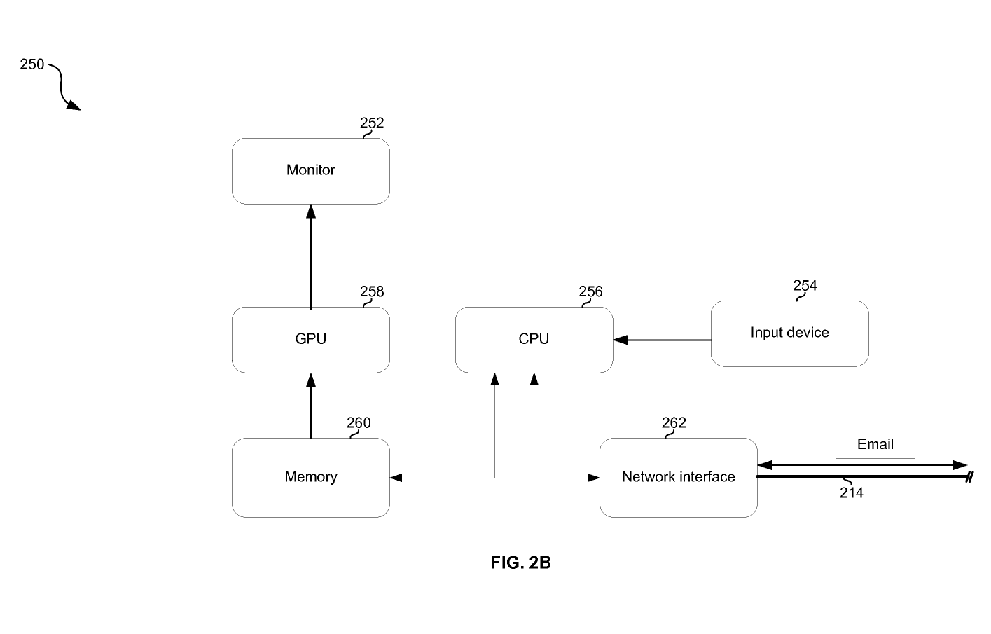

FIG. 2A depicts an example computing device operating as a web and email server. The computing device 200 comprises a central processing unit (CPU) 206, memory circuitry 210, and network interface circuit 212. In an example implementation, the computing device 200 may correspond to the computing device 104b. In another example implementation, the functions of computing device 200 may be distributed across multiple devices (e.g., devices 104 and/or 106) in the same LAN or multiple devices across multiple LANs.

The memory circuitry 210 may comprise, for example, SRAM, DRAM, ROM, FLASH, magnetic storage, and/or any other suitable type of memory. The memory circuitry 210 may store program memory, run-time memory, and/or mass storage.

The network interface circuitry 212 may be operable to transmit and receive physical layer signals via the network link 214. In the receive direction, the network interface circuitry 212 may convert the signals to packets of binary data, and output the packets to the CPU 206 for processing. The network interface circuitry 212 may, for example, receive signals in accordance with Ethernet physical layer protocols, assemble the signals to IP packets and output the IP packets to the CPU 206. In the transmit direction, the network interface circuitry 212 may receive IP packets from the CPU 206, encapsulate the IP packets into Ethernet frames, and transmit the frames onto the link 214 in accordance with Ethernet physical layer protocols.

The CPU 206 may comprise, for example an x86-based processor, an ARM-based processor, or any other suitable circuitry operable to execute instructions (e.g., stored in memory 210) for processing data, generating control signals, and/or otherwise performing, or causing other circuits to perform, functions described herein. In this manner, an operating system and one or more software applications may run on the computing device 200. Such software applications may include, for example, a web server, an email server, an application server, and/or processes for performing various aspects of a communication protocol (e.g., for implementing TCP/IP and interfacing the applications to the network interface 212).

In operation, the computing device 200 may operate as a web server to host an electronic forum via which users can share information by posting messages (creating “posts”) for other users to read and respond to, if desired. A series of posts on a particular subject may be presented as a “thread.” Threads may be categorized into one or more categories. The content of the forum (the posted text, files, information about exiting categories and threads, etc.), account information for users of the forum, and/or associated information (e.g., CSS files, HTML files, scripts, etc.) for serving the content to the users (e.g., to users' web browsers and/or vendor-specific applications (“apps”)) may be stored in a file system and/or database in memory 210. The web server running on the computing device 200 may serve the content by appropriately formatting, packetizing, and transmitting it to the network interface circuit 212 which may then delivery it over the link 214 in accordance with the appropriate network layer and physical layer protocols.

In operation, the computing device 200 may also operate as an email server which accepts emails destined for one or more domains and transmits message originating from the one or more domains. The computing device 200 may be operable to receive emails and parse the received emails to extract one or more fields of the emails and store the contents of such fields to the memory 210 (e.g., to an appropriate place in the database which holds the forum-related contents/information). As for transmitted emails, the computing device 200 may be operable to, for example, generate emails containing forum-related information and/or forum content in response to forum-related activity (e.g., a change in forum content, a change in a user account, a user accessing the forum, a reminder and/or notification set by a user of the forum, etc.) and/or in response to email-related activity (e.g., an email being received, another email being sent, etc.).

FIG. 2B depicts an example computing device operating as a web and email client. In an example implementation, computing device 250 may correspond to each of the computing devices 106a-106c. In other example implementations, however, the functions described as performed by the computing device 200 may be performed by one of computing devices 104a, 104b, and 104c or may be distributed among multiple of the computing devices 104a, 104b, 104c, 106a, 106b, and 106c.

The computing device 250 comprises a monitor 252, an input device 254, a central processing unit (CPU) 256, graphics processing unit (GPU) 258, memory circuitry 260, and network interface circuit 262.

The monitor 252 may comprise circuitry operable to visually present information for viewing by a user of the computing device 250. The monitor 250 may be, for example, an LCD monitor.

The input device 254 may comprise circuitry operable to accept user input and convert the user input to electrical signals understood by the computing device 250. The input device 254 may comprise, for example, a mouse, a keyboard, a touchscreen, and/or the like.

The memory circuitry 260 may comprise, for example, SRAM, DRAM, ROM, FLASH, magnetic storage, and/or any other suitable type of memory. The memory circuitry 260 may store program memory, run-time memory, and/or mass storage.

The GPU 258 may be operable to read data from memory 260 and process the data to format it for output to the monitor 202. For example, the GPU 258 may read data the memory 260, render an image based on the data, and convert the image to video signals suitably formatted for output to the monitor 252.

The network interface circuitry 262 may be operable to transmit and receive physical layer signals via the network link 214. In the receive direction, the network interface circuitry 262 may convert the signals to packets of binary data, and output the packets to the CPU 256 for processing. The network interface circuitry 262 may, for example, receive signals in accordance with Ethernet physical layer protocols, assemble the signals to IP packets and output the IP packets to the CPU 256. In the transmit direction, the network interface circuitry 262 may receive IP packets from the CPU 256, encapsulate the IP packets into Ethernet frames, and transmit the frames onto the link 214 in accordance with Ethernet physical layer protocols.

The CPU 256 may comprise, for example an x86-based processor, an ARM-based processor, or any other suitable circuitry operable to execute instructions for processing data, generating control signals, and/or otherwise performing, or causing other circuits to perform, functions described herein. In this manner, an operating system and one or more software applications may run on the computing device 200. Such software applications may include, for example, a web browser, an email client, a vendor-specific application for interacting with an electronic forum, and/or processes for performing various aspects of one or more communication protocols (e.g., for implementing TCP/IP and interfacing the applications to the network interface 262).

In operation, the computing device 250 may access the electronic forum hosted by the computing device 200. A web browser (or vendor-specific “app”) running on the computing device 250 may request content by, for example, sending HTTP requests (or in accordance with a vendor specific API) to the computing device 200. Received packets carrying requested content may be processed by the network interface 262 and CPU 256 to recover the content and store it to memory 260. The web browser (or “app”) may then cause the content to be rendered by the GPU for presentation in a window on the monitor 252.

In operation, the computing device 200 may also operate as an email client. The email client may fetch emails from an incoming email server that handles an email address associated with the computing device 250. The email client may provide a graphical user interface on the monitor 252 for a user to compose a message using the input device 254. The email client may send composed emails to an outgoing email server that handles an email address associated with the computing device 250.

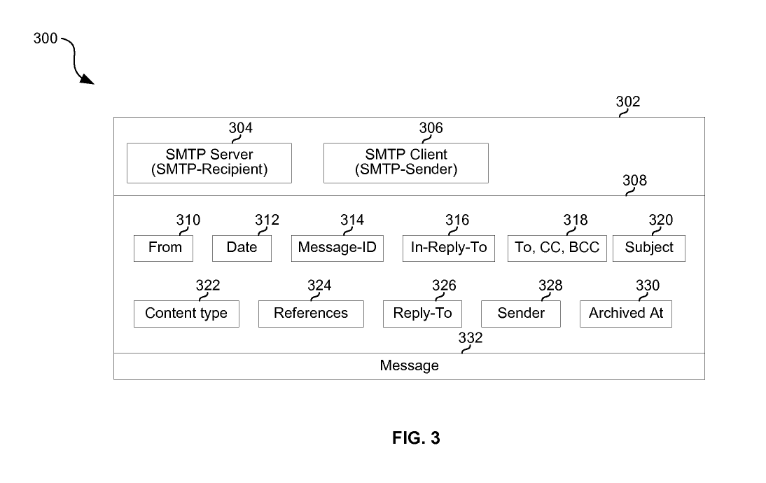

FIG. 3 depicts example fields of an email. The email 300 comprises simple mail transfer protocol (SMTP) header 302, message header 308, and a message 332. The SMTP header 302 comprises a “SMTP recipient” field 304 and a “SMTP sender” field 306. The “SMTP recipient” field 304 may be the email address of the actual sender of email 300. The “SMTP sender” field 306 may be the email address of the actual address to which email 300 is sent.

The message header 308 comprises one or more of a “From” field 310, a “Date” field 312, a “Message-ID” field 314, an “In-Reply-To” field 316, a “To, CC, and/or BCC” field 318, a “Subject” field 320, a “Content Type” field 322, a “References” field 324, a “Reply-To” field 326, a “Sender” field 328, and an “Archived At” field 330.

The “From” field 310 may contain the email address and/or name that the recipient email client may display as the “from” address/name of the email 300. The email address in the “From” field 310 may be different than the email address of the actual sender, which is contained in the SMTP sender field 306. The “Date” field 312 may contain the local time and date when the email 300 was sent. The “Message-ID” field 314 may comprise an automatically generated Message ID (e.g., am alphanumeric value) which may be for preventing multiple delivery and for reference in the “In-Reply-To” field 316. The “In-Reply-To” field 316 may be present if the email 300 is a reply to a previous email. If present, the “Message-ID” field may contain the Message ID of the previous email to which email 300 is a reply. The “To, CC, and/or BCC” field 318 may contain email address(es) and/or name(s) of the intended recipient(s) (primary and/or secondary intended recipient) of the email 300. The “Subject” field 320 may contain a synopsis typed by the person who sent the email 300. The “Content Type” field 322 may contain information about how the message 332 is to be displayed, typically a MIME type. The “References” field 324 may contain Message IDs of each email in the chain that email 300 belongs to (i.e., the Message ID of a first email that email 300 is a reply to, a Message-ID of a second email that the first email was a reply to, etc.). The “Reply-To” field 326 may contain an email address to which replies to email 300 should be sent. The “Sender” field 328 may contain the name and/or email address of the person who sent email 300 on behalf of the name/email address listed in the “From” field 310. The “Archived At” field 330 may contain a link to an archived from of the email 300. The “Message” 332 may contain MIME formatted content such as text, images, file attachments, etc., which may be arranged in one or more fields.

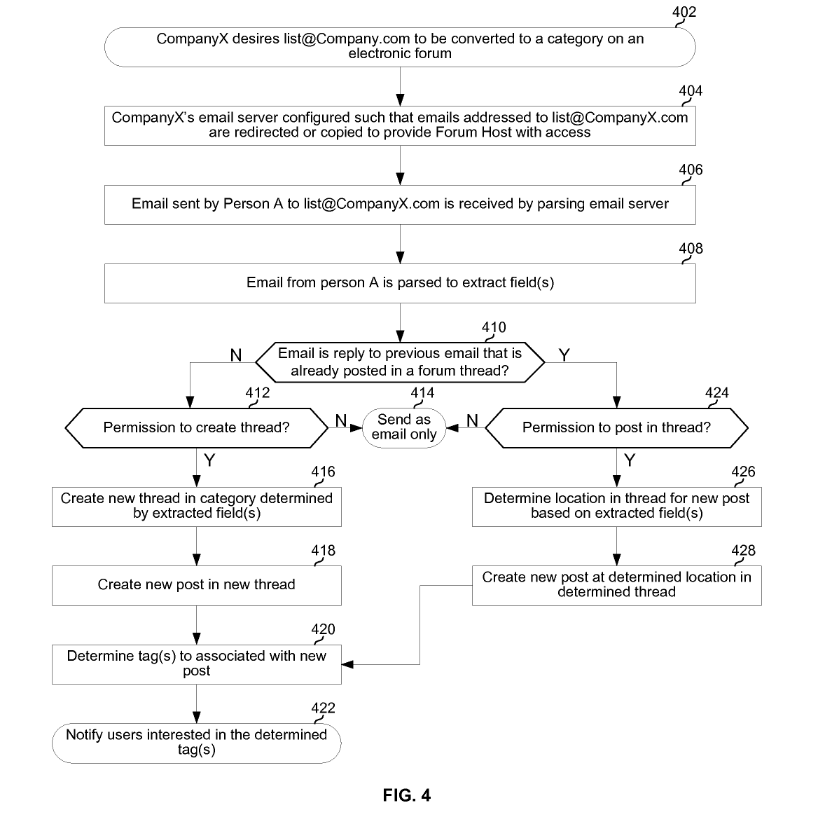

FIG. 4 is a flowchart illustrating an exemplary process for electronic collaboration. The process begins with block 402 in which CompanyX desires that emails sent to an email list “list@CompanyX.com” be posted on an electronic forum.

In block 404, CompanyX's email server (e.g., computing device 104a) is configured such that emails addressed to list@CompanyX.com are redirected or copied to an email address that provides an email parsing server with access to emails sent to list@CompanyX.com. For example, emails sent to list@CompanyX.com may be copied or redirected to CompanyX_Listener@Forum_Host.com. As another example, emails sent to list@CompanyX.com may be copied or redirected to Forum_Host@CompanyX.com.

In block 406, an email sent by Person A to list@CompanyX.com is received by the email parsing server. In an example implementation where the emails are redirected or copied to CompanyX_Listener@Forum Host.com, the email parsing server may be, for example computing device 104b. In an example implementation where the emails are redirected or copied to Forum_Host@CompanyX.com, the email parsing server may be, for example, computing device 104a.

In block 408, the email received in block 406 is parsed by the email parsing server to extract one or more fields such as, for example, one or more of the fields described above with reference to FIG. 3. The extracted fields may be conveyed to the web server that hosts the electronic forum. The web server may reside on a physically separate computing device than the parsing email server, or the two may be running on the same computing device (e.g., device 104b). The extracted fields may be stored to a database, and may be searchable via a graphical interface element of the electronic forum.

In block 410, the web server determines, based on the extracted fields, whether the email is a reply to a previous email that has already been posted to the electronic forum. The determination may be based, for example, on a “Message-ID” field 314 of the email, an “In-Reply-To” field 316 of the email, and/or a “References” field of the field 324. If the email is not a reply to an email already posted to the electronic forum, then the example process advances to block 412.

In block 412, the web server determines whether Person A (the sender of the email) has permission to create a thread in the electronic forum. Such permissions may be explicitly granted (e.g., an access control list may be checked against Person A's email address) and/or may be implicit (e.g., the forum is public or only those explicitly blocked are prevented from create threads and/or posts via email). If Person A does not have permission to create a thread, then, in block 414, the web server may refrain from posting the email to the forum. If the email is not posted to the forum, the email server may or may not send the email to the email addresses belonging to list@CompanyX.com (e.g., based on settings configured by an administrator). In an example implementation, whether or not Person A has permission to create a thread may depend on the domain of Person A's email address (e.g., if Person A has an @CompanyX.com email address then permission may be granted, whereas if Person A has an email address with a different domain, permission may be denied and/or a grant of permission may be required from an administrator or known user).

Returning to block 412, if Person A does have permission to create a thread, then the example process proceeds to block 416.

In block 416, the web server may create a new thread in the forum. The category in which the thread is created may be determined based on the extracted field(s). For example, the category may be determined based on contents of the “To, CC, and/or BCC” field 318, contents of a “Subject” field 320 of the email, and/or contents of the message 332 (e.g., tags present in a text field of the message). During creation of the thread, the web server may associate the thread with the Message ID of the email. In this manner, future replies to the email can be posted to the same thread.

In block 418, the web server may create a new post in the thread created in block 416. A “Body” portion of the post may contain text, images, and/or other content from the message 332. In an example implementation, attachments to the email may be stored to memory and a link to the location may be placed in an “Attachments” portion of the post. In an example implementation, attachments and/or other content of the post created in block 418 may be compared against attachments and/or other contents of other posts and, upon finding a match, links to the other post(s) may be placed in the post created in block 418 and, likewise, a link to the post created in block 418 may be placed in the other post(s). Contents of an “Author ID” portion of the post may be determined based, for example, on a user account associated with Person A's email address, which, in turn, may be determined based on a “From” field 310 of the email. An avatar and/or other information configured in the user account may be placed in the “Author ID” portion of the post. If no user account is associated with Person A's email address then the “Author ID” portion of the post may, for example, simply contain Person A's email address. In an example implementation, if no user account is associated with Person A's email address, an automated email may be sent to Person A inviting Person A to create an account and/or requiring that Person A create an account before the email will be posted to the forum.

In block 420, one or more tags may be associated with the post. The tags may, for example, be selected from a list of standard tags. The tags may, for example, be copied from the message 332 of the email. The tags may, for example, be automatically selected/generated or suggested based on analysis of the extracted field(s) (e.g., search of the message text and/or text of email attachments, image recognition, etc.).

In block 422, users who have indicated an interest in one or more of the tags associated with the new post (e.g., via preferences associated with their user account) may be notified of the new post. The notifications may be in any suitable form such as email, a push notification to their Forum Host app, posting of a message to their user account for the forum, etc.

Returning to block 410, if the email is a reply to a previous email already posted to the electronic forum, block 410 may also comprise determining the category and thread in which the previous email is posted based on the extracted fields. Subsequent to such a determination, the example process advances to block 424.

In block 424, the web server determines whether Person A (the sender of the email) has permission to post in the determined thread. Such permissions may be explicitly granted (e.g., an access control list may be checked against Person A's email address) and/or may be implicit (e.g., the thread is public or only those explicitly blocked are prevented from posting to the thread via email). If Person A does not have permission to post in the thread, then, in block 414, the web server may refrain from posting the email to the thread. If the email is not posted to the thread, the email server may or may not send the email to the email addresses belonging to list@CompanyX.com (e.g., based on settings configured by an administrator). In an example implementation, whether or not Person A has permission to post in the thread may depend on the domain of Person A's email address (e.g., if Person A has an @CompanyX.com email address then permission may be granted, whereas if Person A has an email address with a different domain, permission may be denied and/or a grant of permission may be required from an thread administrator or known user).

Returning to block 424, if Person A does have permission to post in the thread, then the example process proceeds to block 426.

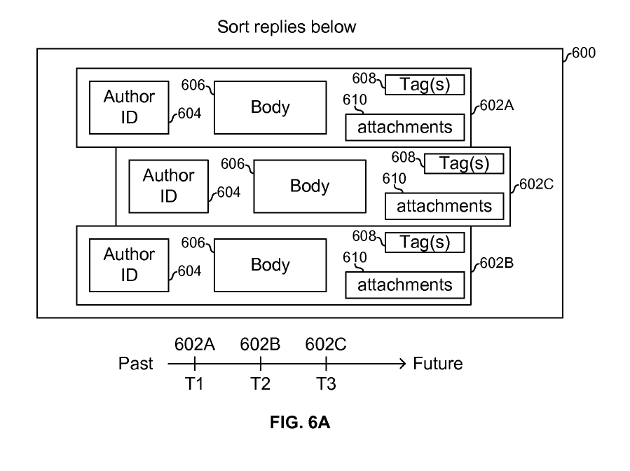

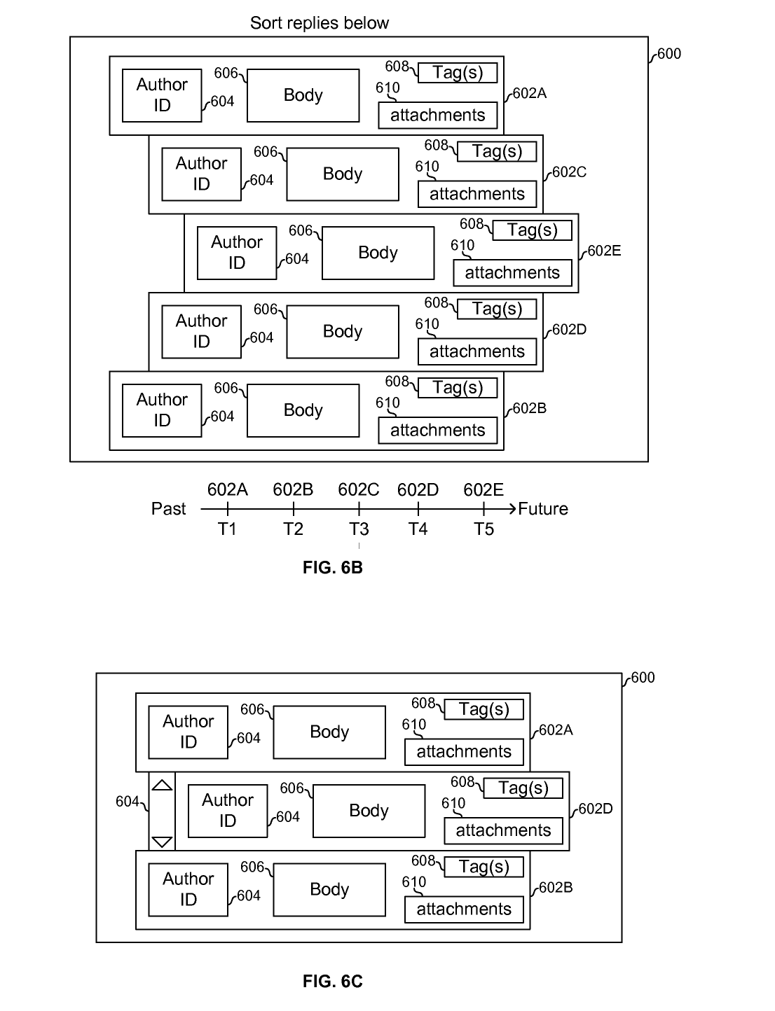

In block 426, a location at which to place the post among other posts in the thread is determined. This determination may be based on one or more of the extracted fields. For example, a “Message-ID” field 314, an “In-Reply-To” field 316, and/or a “References” field 324 of the email may be used to determine where to position the post. Example arrangement/locations of email-created posts are described below with reference to FIGS. 6A-6D.

In block 428, the new post may be created and placed in the location determined in block 428. Following block 428, the process may proceed to block 420, described above.

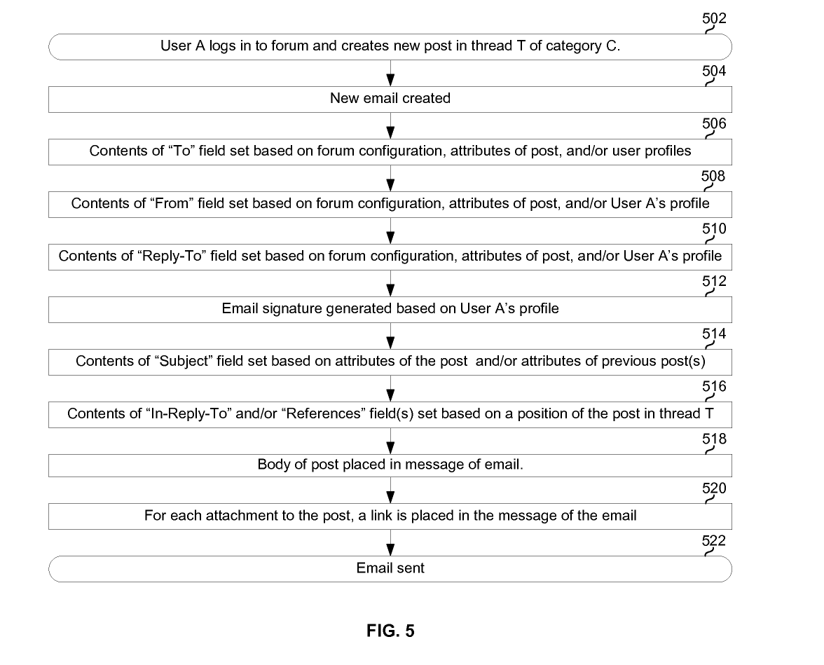

FIG. 5 is a flowchart illustrating an exemplary process for electronic collaboration. The process begins with block 502 in which User A logs into the electronic forum and creates a new post in thread T of category C.

In block 504, in response to User A's post, a new email is created.

In block 506, the contents of a “To, CC, and/or BCC” field 318 of the email may be determined based on forum configuration (e.g., settings configured by a forum administrator), attributes of the post, and/or preference settings in User A's profile and/or other user profiles. User profile settings may include, for example, the option to turn off email alerts for certain time periods, certain forum categories, certain forum threads, certain tags, and/or the like. For example, the Category C in which the post has been created may be associated with an email list (e.g., list@CompanyX.com) and the “To, CC, and/or BCC” field 318 may be populated with the email addresses that (1) belong to the email list and (2) have configured their user profiles to receive forum posts via email. As another example, the post may contain one or more tags and the “To, CC, and/or BCC” field 318 may be populated with email addresses that (1) belong to users who have indicated an interest in such tag(s) and (2) have configured their user profiles to receive forum posts via email.

In block 508, the contents of a “From” field 310 of the email may be determined based on forum configuration (e.g., settings configured by a forum administrator), attributes of the post, and/or preference settings in User A's profile and/or other user profiles. For example, the contents of the “From” field may be set as User A's primary email address from his/her user profile (e.g., UserA@domain.com), may be set as User A's forum email address (e.g., UserA@Forum_Host.com), may be set to User A's name but with an email list address (e.g., User A <list@CompanyX.com>) or any other suitable name and/or address information configured by a forum administrator.

In block 510, contents of a “Reply-To” field 326 of the email may be determined based on forum configuration (e.g., settings configured by a forum administrator), attributes of the post, and/or preference settings in User A's profile and/or other user profiles. For example, one or more of the following may be placed in the “Reply-To” field: User A's primary or forum email address, an email list (e.g., list@CompanyX.com) associated with the Category C, and an email address handled by a parsing email server (e.g., CompanyX_Listener@Forum_Host.com, or Forum Host@CompanyX.com).

In block 512, an email signature is automatically generated and inserted into the email based on, for example, forum configuration, settings in User A's profile in the forum, and/or attributes of the post (e.g., the Category C and/or the thread T).

In block 514, the contents of a “Subject” field 320 may be determined based on attributes of the post and/or attributes of other posts (e.g., attributes of a previous post that the new post is a reply to). Such attributes may include, for example, the Category C in which the post appears, the Thread T in which the post appears, key words in one or more of the posts, attachments to one or more of the posts, tags in one or more of the posts, and/or the like.

In block 516, the contents of an “In-Reply-To” field 316 and/or a “References” field 324 may be determined based on the location of the post in the thread T and the Message-IDs of the new post and the previous posts in the thread. In an example implementation, the order of the Message-IDs may be set based on which posts are in reply to which other(s) of the posts, rather than based on the relative times of the posts. In this manner, an email client may display the chain of emails in the same order that the posts appear when viewing the forum thread (e.g., in a vendor-specific app or web browser).

In block 518, the body of the post is placed in the Message 332. The body of the post may be identified as the appropriate MIME type. In an example implementation, the message may be formatted (e.g., using XML, HTML, CSS, and/or the like) such that it appears in an email client just as the post appears in the vendor-specific app and/or web browser.

In block 520, each file or object that that User A attached to the post may be saved to a network-addressable location, and a link to the location may be placed in the email. In this manner, the size of the email may be kept small and recipients can obtain the attachments, if they choose, by following the links. In an example implementation, the link may be secured. For example, the links may set to expire after a specified time-to-live, accessing the linked locations may require authentication (e.g., accessing from a particular domain, providing a password, answering a security question, etc.). Similarly, in an example implementation, the email may also comprise a link to a location for uploading files or objects that a recipient of the email wishes to attach to a reply email. Such a location may also be secured (e.g., by requiring authentication and/or having a specified time-to-live).

In block 522, the creation of the email is complete and the email is sent (e.g., using SMTP).

FIGS. 6A-6C depict example graphical user interfaces of an electronic forum. FIG. 6A depicts an example thread 500 of the forum in which there are three posts 402A, 402B, and 402C. Each of the posts comprises an Author ID portion 604, a Body portion 606, a tag portion 608, and an attachments portion 610.

The Author ID portion 604 of a particular post may comprise a user name, an avatar, a status indicator, and/or other information associated with a person who created the particular post (either directly in the forum or via email). The body portion 606 of a particular post may comprise the text and/or images entered by the author of the post. The tag portion 608 of a particular post may comprise tags associated with that post. The tags may have been, for example, automatically generated/selected by the forum software based on the content of the author portion 604, the body portion 606, and/or the attachments portion 608 of the particular post and/or other posts in the thread. Additionally or alternatively, the tags may have been entered by the author of the post and/or a viewer of the post (perhaps in response to an automated suggestion). The attachments portion 610 of a particular post may comprise links to files and/or objects that the author of the post attached to the post (either directly in the forum, through an upload link provided via email, and/or by attaching the files and/or objects to an email). The attachments portion 610 may additionally comprise a brief description of the attachments.

FIGS. 6A-6C depict example implementations of an electronic forum in which replies to previous posts are visually grouped, regardless of their time stamps. In FIG. 6A, post 602A was created in thread 600 based on one or more fields of an email sent at time T1, post 602B was created based on one or more fields of an email sent at time T2, and post 602C was created based on one or more fields of an email that was sent at time T3, but was a reply to the email sent at time T1. Even though the email corresponding to post 602C was sent after the email corresponding to the post 602B, the location of post 602C in the forum (as rendered by a vendor-specific app or web browser, for example) is after post 602A and before 602B.

FIG. 6B shows another scenario showing two posts 602D and 602E corresponding to two additional emails. Post 602D corresponds to an email sent, at time T4, in reply to the email corresponding to post 602A. Post 602E corresponds to an email sent, at time T5, in reply to the email corresponding to post 602C.

FIG. 6C shows an example implementation where posts at a certain reply-level are scrollable and/or filterable so as to reduce the visual information presented to a viewer at one time. In the scenario shown, the user has chosen to see all messages on the reply-level of posts 602A and 602B, but has chosen to filter out and/or scroll posts that are one or more reply-levels down (posts that are replies to posts 602A and 602C and post that are replies to those replies, etc.). The filtering and/or scrolling may be done via one or more interface elements 604.

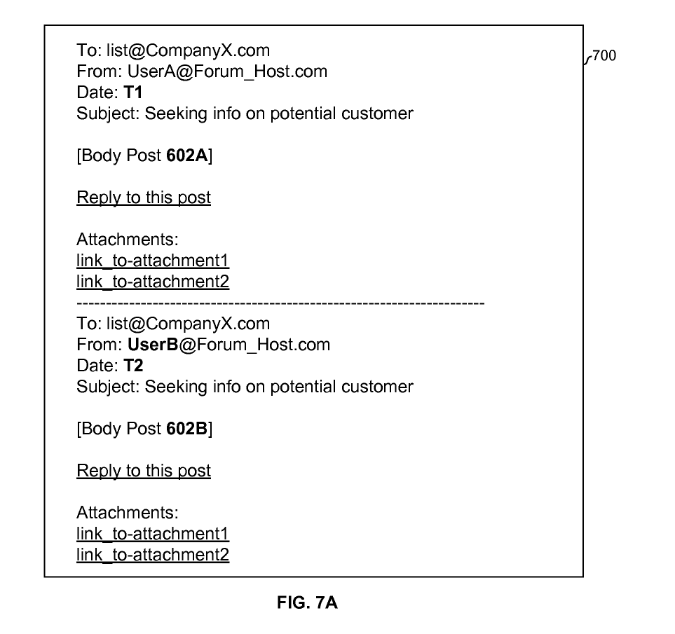

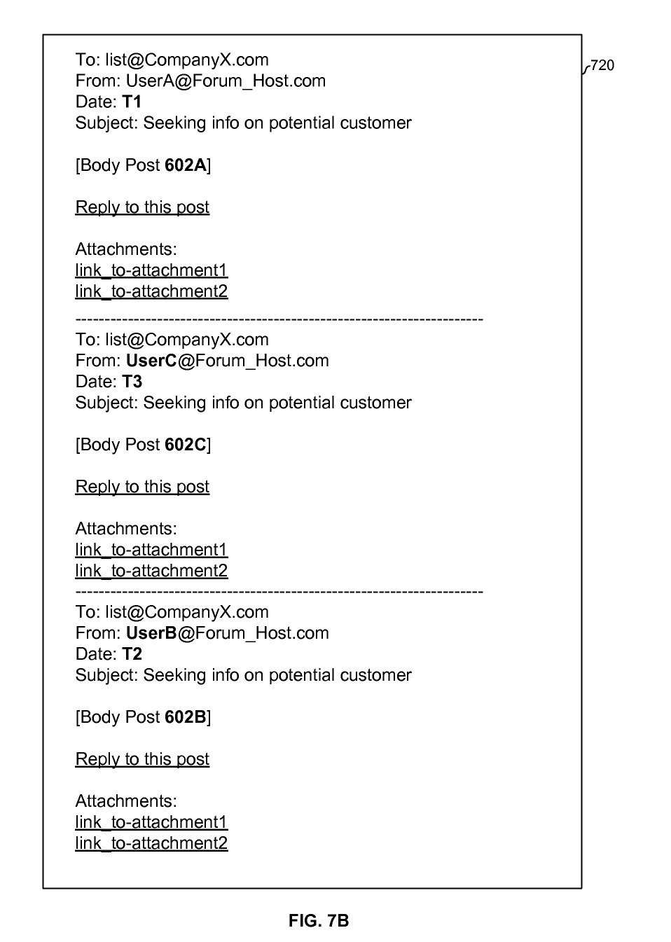

FIGS. 7A and 7B depicts example emails corresponding to the thread shown in FIG. 6A. FIG. 7A shows an example email 700 which may be received by User C (the author of post 602C) in response to the creation of post 602B. In the example implementation, preferences (either User C's preferences and/or a forum administrator's preferences) have been set to show newer posts/emails below older posts of the same reply-level. The preferences may alternatively be configured to show newer posts above older posts of the same reply-level.

Upon receiving the email 700, User C may client the “Reply to this Post” link associated with email/post 602A. User C may then compose an email, which upon sending, may be parsed by a parsing email server and posted to the forum as post 602C. In response to the post 602C, an email, such as the email 720 shown in FIG. 7B, may be sent to users that have elected to received emails corresponding to posts into thread 600.

In the example implementation depicted, the email is arranged such that newer emails are below older emails of the same reply-level, and a location of replies is determined based on which post/email to which they are replying. Thus, the content corresponding to post 602A is at the top of email 720, followed by the content corresponding to post 602C (which was in reply to 602A), and then the content corresponding to post 602B is at the bottom of email 720. In an example implementation, since the content that triggered the email 720 (the content corresponding to post 602C) may be in the middle of the email 720, one or more visual indications may be given to alert the reader of the email at to which content triggered the email 720. For example, the content corresponding to post 602C may be bolded or highlighted.

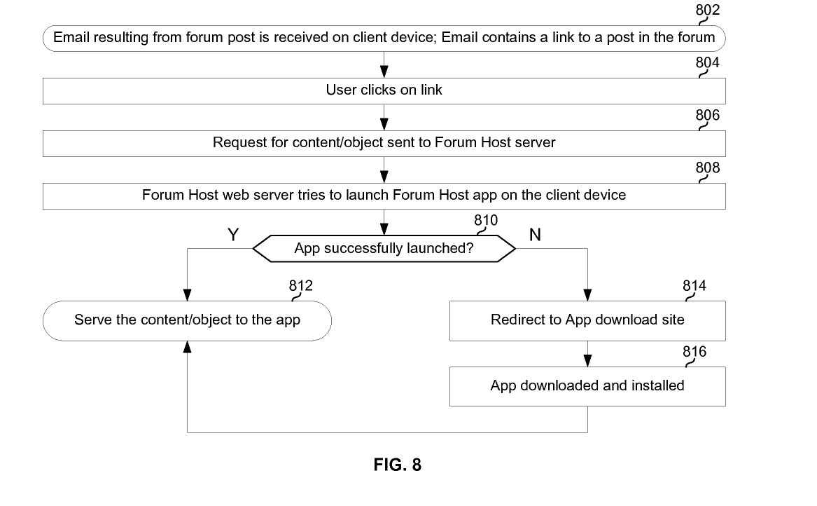

FIG. 8 is a flowchart illustrating an exemplary process for electronic collaboration. The process begins with block 802 in which an email resulting from a forum post is received on a client computing device (e.g., a smart phone). The email comprises a link to a post in an electronic forum (e.g., a “reply to this email in the forum” link). In block 804, a user of the client computing device clicks (e.g., with a mouse or with a finger on a touchscreen) the link. In block 806, in response to the click of the link, a request for content/object(s) is sent to Forum Host's server (e.g., 102b). In block 808, the serer tries to launch a Forum Host app on the client computing device (e.g., by using a URL registered to the Forum Host app). In block 810, if the launch of the Forum Host app is successful, then in block 812, the requested content/object(s) are served via the Forum Host app. Conversely, if the launch of the Forum Host app fails, then in block 814, the client computing device is redirected to a site from which the Forum Host app can be downloaded. In block 816, the Forum Host app is downloaded an installed. After step 816, the process proceeds to block 812, described above.

Various implementations of this disclosure may enable collaboration on an electronic forum among “insiders,” who have access to an electronic forum (e.g., employees of CompanyX that have access to LAN 102a) and “outsiders,” (e.g., employees of CompanyY, who do not have access to CompanyX's LAN 102a). Specifically, Email may act as a conduit between outsiders and a forum to which access is generally restricted to insiders. Email may provide limited or controlled access to the forum by such outsiders. For example, what may be posted and/or viewed in the forum via email may be different than what may be posted and/or viewed natively when logged into the forum (e.g., on a browser or vendor-specific app).

Similarly, email may serve as a bridge between two forums which have different “insiders” and “outsiders.” For example, a first forum may generally be restricted to employees of CompanyX and a second forum may generally be restricted to employees of CompanyY, but each of the two forums may have one or more categories or threads which are common (or mirrored) on the other forum. For example, an employee of CompanyY may log into the CompanyY Forum and create a post in a common thread. In response to the post, an email may be generated by a server hosting the CompanyY Forum and sent to a server hosting the CompanyX forum. The server hosting the CompanyX forum may parse the email, recreate the post from the email, and post the email to the corresponding thread in the CompanyX forum.

Other implementations may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the processes described herein.

Accordingly, the present method and/or system may be realized in hardware, software, or a combination of hardware and software. The present method and/or system may be realized in a centralized fashion in at least one computing system, or in a distributed fashion where different elements are spread across several interconnected computing systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip.

The present method and/or system may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. Therefore, it is intended that the present method and/or system not be limited to the particular implementations disclosed, but that the present method and/or system will include all implementations falling within the scope of the appended claims.

What is claimed is:

1. A method comprising:
performing in a computing device:
receiving a first email via a network connection;
parsing said first email to extract one or more fields of said first email;
determining, based on said extracted one or more fields of said first email, a category of an electronic forum with which to associate said first email;
determining, based on said extracted one or more fields of said first email, a thread of said determined category of said electronic forum with which to associate said first email
associating, in a memory, said first email with said determined thread of said determined category; and
presenting content of said first email in a first post in said determined thread of said determined category of said electronic forum.

2. The method of claim 1, wherein:
said one or more fields of said first email include a “To” field, a “Cc” field, and/or a “Bcc” field;
said association of said email with said determined category of said electronic forum is based on said “To” field, said “Cc” field, and/or said “Bcc” field.

3. The method of claim 1 wherein:
said one or more fields of said first email include a “Message-ID” field, an “In-Reply-To” field, and/or a “References” field;
said association of said email with said determined thread is based on said “Message-ID” field, said “In-Reply-To” field, and/or said “References” field.

4. The method of claim 1, wherein said one or more fields of said first email include a “from” field, and said method comprises:
determining a user of said forum to be indicated as author of said first post based on said “from” field of said first email; and
displaying an identifier of said determined user along with said first post.

5. The method of claim 1, comprising:
determining a tag to associate with said first post based on said extracted one or more fields; and
associating, in a memory, said determined tag with said first post.

6. The method of claim 5, comprising:
automatically sending, in response to said determining said tag, a notification of said first post to a user of said forum whose profile indicates an interest in said determined tag.

7. The method of claim 1, wherein said extracted one or more fields of said first email include a “Message-ID” field, an “In-Reply-To” field, and/or a “References” field, and said method comprises:
determining a location in said determined thread at which to present said first post based on said “Message-ID” field, said “In-Reply-To” field, and/or said “References” field.

8. The method of claim 7, comprising:
presenting, on said electronic display, said first post at a position between a second post in said determined thread and a third post in said determined thread, wherein:
said second post is generated from a second email;
said third post is generated from a third email;
said first email is a reply to said third email;
said second email is not a reply to said third email;
said second email is sent earlier in time than said first email.

9. The method of claim 1, comprising:
storing an attachment of said first email to a location corresponding to a uniform resource locator (URL); and
presenting said URL in said first post.

10. A method comprising:
performing in a computing device:
generating, for presentation on an electronic display, a graphical user interface of an electronic forum, wherein said graphical user interface enables users of said forum to create posts in said electronic forum;
generating an email in response to a user of said electronic forum creating a post in said electronic forum, wherein:
content of said generated email comprises content of said post; and
said generated email is addressed to an email list determined based on a attributes of a thread of said forum in which said post was created.

11. The method of claim 10, wherein a subject field of said generated email is determined based on attributes of said thread in which said post was created.

12. The method of claim 10, comprising
storing an attachment of said post to a network-addressable location; and
inserting a hyperlink to said network-addressable location into said generated email.

13. The method of claim 10, comprising:
determining a list of recipients to which said generated email message is to be sent based on a category of said electronic forum in which said post was created.

14. The method of claim 10, comprising:
automatically associating one or more tags with said post based on content of said first post.

15. The method of claim 14, comprising:
determining a list of recipients to which said generated email is to be sent based on said one or more tags.

16. The method of claim 14, comprising:
automatically sending a notification of said post to a user of said forum whose user profile indicates an interest in posts associated with said one or more tags.

17. The method of claim 10, comprising:
populating a “from” field of said first email based on a user profile associated with said user in said electronic forum.

18. The method of claim 15, comprising:
retrieving information from a user profile associated with said user in said electronic forum;
generating a signature comprising said retrieved information; and
inserting said generated signature into said generated email.

19. The method of claim 1, wherein:
said content of said email comprises content of one or more other posts in said thread of said forum;
an ordering of said content of said post and said content of said one or more other posts in said email matches an ordering of said post and said one or more other posts in said thread of said forum.

20. A system comprising:
one or more servers operable to:
parse a first email to extract one or more fields of said first email;
determine a category of an electronic forum with which to associate said first email based on said extracted one or more fields of said first email;
determine a thread of said determined category of said electronic forum with which to associate said first email based on said extracted one or more fields of said first email;
associate, in a memory, said first email with said determined thread of said determined category;
present content of said first email in a first post in said determined thread of said determined category of said electronic forum; and
generate a graphical user interface of said electronic forum, wherein users of said electronic forum can create a post in said forum via said graphical user interface;
generate a second email in response to a user of said electronic forum creating a second post in a particular category of said electronic forum, wherein:
content of said second email comprises content of said second post; and
said second email is addressed to an email list that is determined based on said particular category of said forum in which said post was created.
